(19) United States
(12) Patent Application Publication
(10) Pub. No.: US 2008/0271788 A1
(43) Pub. Date: Nov. 6, 2008

(54) Flow Rate Switching Type Flow Divider

(76) Inventors: Takeharu Matsuzaki, Kariya-Shi (JP); Shigeto Nakajima, Nagano-shi (JP)

Correspondence Address: MORGAN & FINNEGAN, L.L.P., 3 WORLD FINANCIAL CENTER, NEW YORK, NY, 10281-2101, US

(21) Appl. No.: 11/667,053

(22) PCT Filed: Nov. 8, 2005
(86) PCT No.: PCT/JP05/20780

§ 371 Date: May 6, 2008

(30) Foreign Application Priority Data
Nov. 8, 2004 (JP) 2004-323095

(51) Int. Cl. F16K 31/12

(52) U.S. Cl. 137/115.13

(57) ABSTRACT

A flow rate switching type flow divider for distributing fluid from a pump to a priority flow circuit and a surplus flow circuit. A flow divider valve arranged along a first line includes a first restriction to restrict flow rate of the fluid from the supply flow path to the priority flow path. A switch valve is arranged along a second line that differs from the first line so as to communicate with the supply flow path through the flow divider valve at a location upstream from the first restriction. The switch valve switches an opening amount of a connection flow path that bypasses the first restriction and extends from the supply flow path to the priority flow path. The switch valve includes a second restriction arranged in the switch valve for restricting flow rate of fluid flowing through the connection flow path.

### TECHNICAL FIELD

The present invention relates to a flow rate switching type flow divider for supplying fluid from a pump at a predetermined flow rate to a priority flow circuit, while also supplying fluid through a tributary flow to a surplus flow circuit.

### BACKGROUND ART

In the prior art, known flow rate control valves and load sensing flow priority valves supply hydraulic oil, which functions as an operating fluid, from a pump to a priority flow circuit at a predetermined flow rate, and supply the remaining oil to a surplus flow circuit. Japanese Laid-Open Patent Publication No. 7-323855 describes a flow priority valve that has a body including a supply port, a control flow port, and a surplus flow port. A main spool is accommodated in the body. The main spool has a first end, facing toward a pilot chamber, and an opposite second end. A casing member is fitted to the body so as to face the second end of the main spool. An auxiliary spool is movably accommodated in the casing member. A control orifice, of which the open amount is varied in accordance with the position of the auxiliary spool, is formed in the casing member. The supply port communicates with the control flow port through the control orifice. The pressure upstream from the control orifice acts on the pilot chamber. The pressure of the control flow port acts on one end of the auxiliary spool. The open amount of the control orifice is enlarged when the pressure of the control flow port increases and moves the auxiliary spool.

Furthermore, Japanese Laid-Open Patent Publication No. 55-155983 describes a flow rate control valve including a first plunger and a second plunger. The first plunger includes a first flow path, connecting a pump port of the flow rate control valve to a control flow port, and a first orifice formed in the first flow path. A second orifice is formed in the first plunger. The second orifice is included in a second flow path extending from the pump port to the control flow port. An increase in the pressure of the control flow port moves the second plunger and opens the second flow path. When the pressure of the control flow port is low, the hydraulic oil is guided from the pump port to the control flow port only through the first orifice, or the first flow path.

As mentioned above, the load sensing flow priority valve described in Japanese Laid-Open Patent Publication No. 7-323855 and the flow rate control valve described in Japanese Laid-Open Patent Publication No. 55-155983 both supply hydraulic oil from a pump to a priority flow circuit at a predetermined flow rate and supply the remaining oil to a surplus flow circuit. In the load sensing flow priority valve of Japanese-Laid-Open Patent Publication No. 7-323855, the auxiliary spool is moved to vary the open amount of the control orifice and switch the predetermined flow rate at which hydraulic oil is supplied to the control flow port, or the priority flow circuit. Further, in the flow rate control valve described in Japanese Laid-Open Patent Publication No. 55-155983, the second plunger is moved to open the second flow path, which extends through the second orifice, and switch the predetermined flow rate of the hydraulic oil supplied to the control flow port, or priority flow circuit.

In the flow priority valve of Japanese Laid-Open Patent Publication No. 7-323855, however, the main spool, the casing member, and the auxiliary spool are coaxially arranged. This increases the dimension of the entire priority valve in the axial direction of the spool. Therefore, a long layout space is required in the axial direction of the spool in order to connect the priority valve to other devices. When designing the priority valve so as to enable the priority valve to be arranged in a predetermined layout space having a limited dimension in the longitudinal direction, the valve is affected by many restrictions resulting from various conditions, such as the spool length, spool stroke length, and specification of the incorporated spring. These restrictions may cause loss or increase of pressure in the hydraulic circuit and destabilize the control flow rate.

In the flow rate control valve of Japanese Laid-Open Patent Publication No. 55-155983, the second flow path, which the second plunger opens and closes, communicates with the pump port through a tributary path upstream from the first plunger. That is, the hydraulic oil from the pump port that does not pass through the first orifice is directed to the control flow port through the tributary path, the second plunger, and the second orifice, or second flow path. In the flow rate control valve, the fluid circuit has a complex structure in order to move the second plunger and open the second flow path, which extends through the second orifice. That is, the second flow path, which includes the second orifice, branches from the first flow path upstream from the first plunger. Thus, the second flow path is long and extends in a complicated manner.

### DISCLOSURE OF THE INVENTION

It is an object of the present invention to provide a flow rate switching type flow divider prevented from being lengthened in the axial direction of the spool so as to enable miniaturization while simplifying the circuit structure.

One aspect of the present invention is a flow rate switching type flow divider for distributing fluid supplied from a pump to a priority flow circuit and a surplus flow circuit. The flow divider is provided with a housing including a pump port connectable to the pump, a priority flow port connectable to the priority flow circuit, a surplus flow port connectable to the surplus flow circuit, a supply flow path extending from the pump port, a priority flow path extending from the priority flow port, and a surplus flow path extending from the surplus flow port. A flow divider valve is arranged in the housing so as to communicate with the supply flow path, the priority flow path, and the surplus flow path. The flow divider valve distributes fluid from the supply flow path to the priority flow path and the surplus flow path. The flow divider valve is arranged along a first line. A first restriction is arranged in the flow divider valve between the supply flow path and the priority flow path to restrict flow rate of the fluid from the supply flow path to the priority flow path. A switch valve is arranged in the housing along a second line that differs from the first line so as to communicate with the priority flow path and communicate with the supply flow path through the flow divider valve at a location upstream from the first restriction. A connection flow path bypassing the first restriction extends from the supply flow path to the priority flow path. The switch valve switches connection between the supply flow path and the priority flow path through the connection flow path. A second restriction is arranged in the switch valve for restricting flow rate of fluid flowing from the supply flow path via the switch valve and into the priority flow path.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view of the flow rate switching type flow divider according to a preferred embodiment of the present invention and shows the flow divider in a neutral state;

FIG. 2 is a partially enlarged cross-sectional view of the flow divider of FIG. 1, showing a power steering device in a no-load state and the load circuit in a no-load state;

FIG. 3 is a partially enlarged cross-sectional view of the flow divider shown in FIG. 1, showing a power steering device in a load state and the load circuit in an actuated state;

FIG. 4 is a partially enlarged cross-sectional view of the flow divider of FIG. 1, showing a power steering device in an actuated state; and

FIG. 5 is a partial cross-sectional view illustrating the operation of the flow divider of FIG. 1, showing a power steering device in an actuated state.

### BEST MODE FOR CARRYING OUT THE INVENTION

A preferred embodiment of the present invention will now be described hereinafter with reference to the drawings. The flow rate switching type flow divider of the present invention may be widely used for applications in which fluid from a pump is distributed to a priority flow circuit at a predetermined flow rate and to a surplus flow circuit.

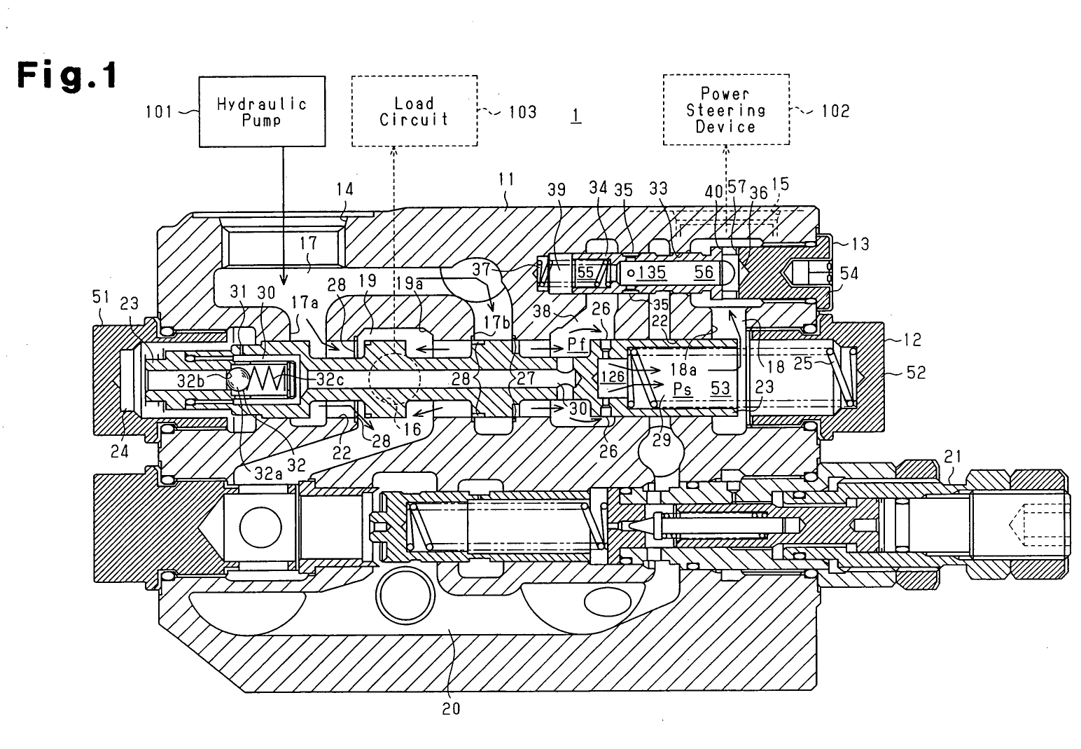

FIG. 1 is a cross-sectional view of a flow rate switching type flow divider 1. The flow rate switching type flow divider 1 may be applied to, for example, a forklift so as to distribute hydraulic oil, which functions as an operating fluid, supplied from a hydraulic pump 101 to a hydraulic power steering device 102, which functions as a priority flow circuit, and to a load circuit 103, which functions as a surplus flow circuit. The load circuit 103 functions as an actuator circuit for controlling the operation of various types of hydraulic actuators used for handling loads. The flow rate switching type flow divider 1 is not necessarily limited to the above application. For example, the present invention may be applied to a forklift that uses other hydraulic circuits as the priority flow circuit and surplus circuit. The present invention may also be used to control hydraulic circuits of equipment other than forklifts.

The flow rate switching type flow divider 1 shown in FIG. 1 is arranged in a hydraulic circuit of a forklift and is generally box-shaped. The flow rate switching type flow divider 1 includes a body block 11 and a flow divider valve 12 and switch valve 13, which are incorporated in the body block 11. FIG. 1 shows the flow rate switching type flow divider 1 in a neutral state, in which the power steering device 102 and load circuit 103 are in a de-actuated state (not operated by the operator). In FIGS. 1 to 5, the broken lines indicate the power steering device 102 and load circuit 103 in a de-actuated state, and the solid lines indicate the power steering device 102 and load circuit 103 in an actuated state.

As shown in FIG. 1, a pump port 14, a priority flow port 15, and a surplus flow port 16 are formed in the body block 11 so as to open to the exterior. The pump port 14 is connected downstream from the hydraulic pump 101, which supplies hydraulic oil in the forklift. The priority flow port 15 is connected to the power steering device 102 of the forklift. The surplus flow port 16 is connected to the load circuit 103 of the forklift.

In FIG. 1, the surplus flow port 16, which is indicated by the double-dotted line, is formed so as to open at a position above the cross-sectional plane shown in FIG. 1. The hydraulic oil supplied from the hydraulic pump 101 flows from the pump port 14 to the supply flow path 17. The hydraulic oil then flows from the supply flow path 17 to a branching priority flow path 18 and a branching surplus flow path 19. The hydraulic oil that passes through the priority flow path 18 is supplied from the priority flow port 15 to the power steering device 102. The hydraulic oil that flows through the surplus flow path 19 is supplied from the surplus flow port 16 to the load circuit 103.

The supply flow path 17, the priority flow path 18, and the surplus flow path 19, which form a passage for supplying hydraulic oil from the hydraulic pump 101, are formed in the body block 11. The supply flow path 17 has an upstream end communicating with the pump port 14 and a downstream end communicating with the flow divider valve 12, which are incorporated in the body block 11. The priority flow path 18 has an upstream end communicating with the flow divider valve 12 and a downstream end communicating with the priority flow port 15. The priority flow port 15 communicates with the priority flow path 18 at a position under the plane of FIG. 1. The surplus flow path 19 has an upstream end communicating with the flow divider valve 12 and a downstream end communicating with the surplus flow port 16.

The body block 11 includes a tank flow path 20 that extends from the surplus flow path 19. The tank flow path 20 communicates with a tank (not shown). An unload pressure compensation valve 21 is also incorporated in the body block 11 together with the flow divider valve 12 and the switch valve 13. The unload pressure compensation valve 21 regulates the flow rate of hydraulic oil from the tank flow path 20 to the tank.

The flow divider valve 12 is incorporated in the body block 11 as described above. The flow divider valve 12 communicates with the priority flow path 18 and surplus flow path 19 and distributes the hydraulic oil from the supply flow path 17 to the priority flow path 18 and the surplus flow path 19. The arrows shown in FIGS. 1, 2, 3, and 5 indicate the flow direction of the hydraulic oil supplied from the pump port 14. The flow divider valve 12 includes a first spool hole 22, a first spool 23, a first cap 51, a second cap 52, a first pilot chamber 24, a first coil spring 25, a first spring chamber 29, a pair of first restrictions 26, a third restriction 27, and a fourth restriction 28.

The first spool hole 22 is a through hole having a circular cross-section and extends through the body block 11 in the lateral direction of FIG. 1. The supply flow path 17, the priority flow path 18, and the surplus flow path 19 each communicate with the first spool hole 22. The supply flow path 17, which extends from the pump port 14, branches into two tributaries that communicate with the first spool hole 22. That is, the supply flow path 17 has a first downstream end 17a that communicates with the left end of the first spool hole 22, as viewed in FIG. 1, and a second downstream end 17b that communicates with the middle of the first spool hole 22, as viewed in FIG. 1. The surplus flow path 19 has an upstream end 19a that communicates with the first spool hole 22 at an intermediate position between the first downstream end 17a and second downstream end 17b. Furthermore, the priority flow path 18 has an upstream end 18a that communicates with the right end, or most downstream end of the first spool hole 22.

The first cap 51 is fitted to the left opening of the first spool hole 22, as viewed in FIG. 1. The interior of the first cap 51 defines the first pilot chamber 24. The second cap 52 is fitted to the right opening of the first spool hole 22, as viewed in FIG. 1.

The first spool 23 is movably arranged in the first spool hole 22. The left end of the first spool 23 is located in the first pilot chamber 24. A cavity 53, which opens toward the second cap 52, is formed in the right end of the first spool 23. The cavity 53 and interior of the second cap 52 define the first spring chamber 29. The first spring chamber 29 accommodates the first coil spring 25 that extends in the lateral direction, as viewed in FIG. 1. The left end of the first coil spring 25 is accommodated in the cavity 53 to urge the first spool 23 to the left, that is, toward the first pilot chamber 24.

The position of the first spool 23 is determined in accordance with the balance between the force produced by the difference of the hydraulic pressures of the first spring chamber 29 and first pilot chamber 24 to urge the first spool 23 toward the first coil spring 25 and the force applied by the first coil spring 25 to urge the first spool 23 toward the first pilot chamber 24. Operation of the power steering device 102 or the load circuit 103 changes the hydraulic pressures of the first spring chamber 29 and the first pilot chamber 24. This momentarily imbalances the forces applied to the first spool 23. As a result, the first spool 23 moves in the axial direction so as to reestablish the balance. This causes hydraulic oil to be supplied at a predetermined flow rate to the priority flow path 18 and varies the flow rate of the hydraulic oil supplied to the surplus flow path 19.

The pair of first restrictions 26 are located between the supply flow path 17 and the priority flow path 18. Each first restriction 26 is formed by a restriction orifice, or fixed restriction, to restrict the flow rate of the hydraulic oil from the supply flow path 17 to the priority flow path 18. A communication passage 38 extends around the first spool hole 22 between the supply flow path 17 and the priority flow path 18 in the body block 11. Each first restriction 26 communicates with the communication passage 38 at the outer surface of the first spool 23. The first restrictions 26 radially extend into the first spool 23 and communicate with the cavity 53 of the first spool 23. The cross-sectional area of the first restrictions 26 decreases from the exterior side toward the interior side of the first spool 23. Hydraulic oil flows from the supply flow path 17 to the communication passage 38 and enters the first restrictions 26 from the radially outer side of the first spool 23. Then, the hydraulic oil flows through the cavity 53 of the first spool 23 and into the priority flow path 18. The flow path that connects the supply flow path 17 to the priority flow path 18 through the first restriction 26 is referred to as a first flow path 126. The cavity 53 functions as an internal passage defined in the first spool 23. The fluid that has passed through the first restriction 26 flows into the cavity 53 and to the priority flow path 18.

The pair of first restrictions 26 are located at symmetric positions about the axis of the first spool 23. Therefore, the hydraulic oil flowing into the first restrictions 26 at the two locations offsets the fluid force applied to the first spool 23 in directions perpendicular to the axial direction of the first spool 23.

Furthermore, the third restriction 27 and the fourth restriction 28 of the flow divider valve 12 are located at positions upstream from the first restriction 26. More specifically, the third restriction 27 is located at a position in which the supply flow path 17 communicates with the communication passage 38. That is, the third restriction 27 is formed between the supply flow path 17 and the priority flow path 18. The fourth restriction 28 is located at a position in which the supply flow path 17 communicates with the surplus flow path 19. The third restriction 27 and the fourth restriction 28 are each defined between the first spool 23 and the wall defining the first spool hole 22. More specifically, the third restriction 27 and fourth restriction 28 are each defined by a notch formed in the wall surface of the first spool hole 22 and a notch formed in the outer surface of the first spool 23. The third restriction 27 and fourth restriction 28 are variable restrictions with an open amount that is varied in accordance with the position of the first spool 23 in the axial direction.

A pilot flow path 30 is formed in the first spool 23 of the flow divider valve 12. The right end of the pilot flow path 30, as viewed in FIG. 1, opens to the outer surface of the first spool 23 between the first restriction 26 and the third restriction 27. From this position, the pilot flow path 30 extends axially through the first spool 23 in the leftward direction, that is, toward the first pilot chamber 24. The left end of the pilot flow path 30 communicates with the first pilot chamber 24 through a damper orifice 31, which is formed on the left end of the first spool 23. Thus, the hydraulic pressure of the communication passage 38, which is upstream from the first restriction 26 and downstream from the third restriction 27, is communicated to the first pilot chamber 24 through the pilot flow path 30. A check valve 32 is arranged in the left end of the first spool 23 to prevent hydraulic oil of the pilot flow path 30 from entering the first pilot chamber 24. The check valve 32 includes a ball-shaped valve body 32a, a valve seat 32b formed at the left end of the first spool 23, and an urging spring 32c for urging the valve body 32a toward the valve seat 32b. When the force urging the valve body 32a away from the valve seat 32b, produced by the hydraulic pressure of the first pilot chamber 24, is greater than the force urging the valve body 32a against the valve seat 32b, produced by the urging spring 32c and the hydraulic pressure of the pilot flow path 30, the check valve 32 opens and enables hydraulic oil to flow from the first pilot chamber 24 into the pilot flow path 30. In other words, the first restriction 26 and the third restriction 27 are connected by the communication passage 38 communicated with the first pilot chamber 24 through the pilot flow path 30 formed in the first spool 23.

The switch valve 13 is arranged along a line that differs from the line on which the flow divider valve 12 is arranged. More specifically, the flow divider valve 12 and the switch valve 13 are arranged along parallel lines extending in the lateral direction, as viewed in FIG. 1. The switch valve 13 communicates with the priority flow path 18. Further, the switch valve 13 also communicates with the supply flow path 17 through the flow divider valve 12 and communication passage 38 upstream from the first restriction 26. The switch valve 13 functions to connect and disconnect the supply flow path 17 and the priority flow path 18 with a second flow path 135, which does not extend through the first restrictions 26 and which is separate from the first flow path 126, which extends through the first restrictions 26. The switch valve 13 includes a second spool hole 33, a second spool 34, second restrictions 35, a second pilot chamber 36, a second coil spring 37, and a second spring chamber 39. The second flow path 135 functions as a connection flow path bypassing the first restriction 26 and extending from the supply flow path 17 to the priority flow path 18. The switch valve 13 switches connection between the supply flow path 17 and the priority flow path 18 through the second flow path 135.

Like the first spool hole 22, the second spool hole 33 is a hole having a circular cross-section. The second spool hole 33 extends laterally from the right end toward the center of the body block 11. The right end, or downstream portion of the second spool hole 33, communicates with the priority flow path 18. The left end, or upstream portion of the second spool hole 33, communicates with the first spool hole 22 through the communication passage 38. A third cap 54 is fitted to the right opening of the second spool hole 33.

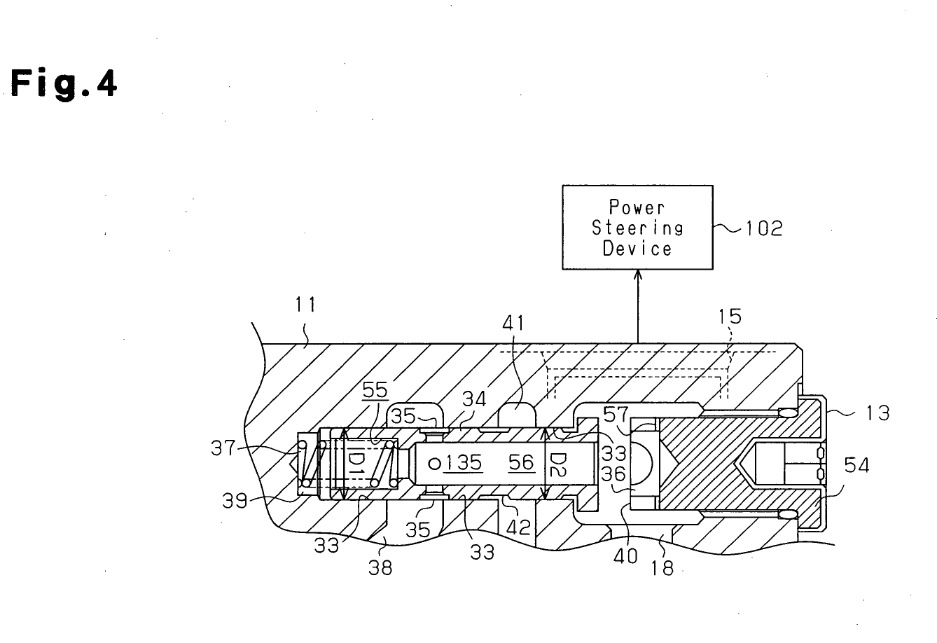

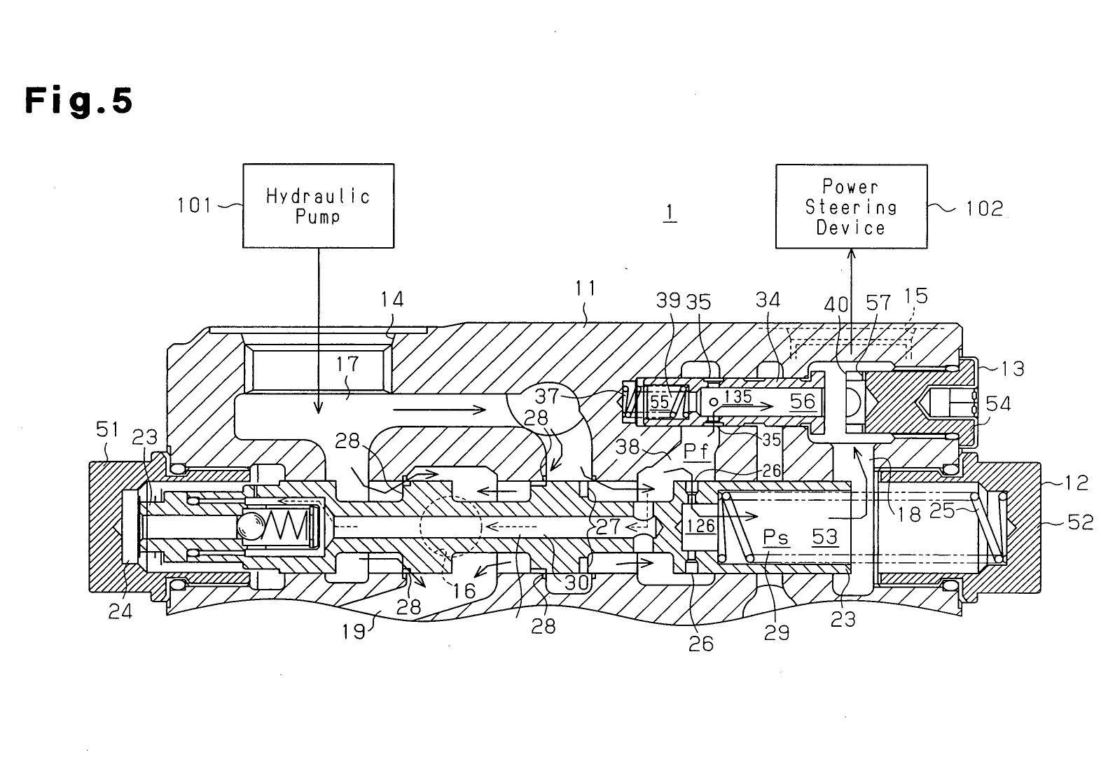

The second spool 34 is movably arranged in the second spool hole 33. The right end of the second spool 34 is located in the second pilot chamber 36, which is located at the intersection of the second spool hole 33 and the priority flow path 18. A cavity 55 opening to the left is defined in the left end of the second spool 34. The cavity 55 and the left end of the second spool hole 33 define the second spring chamber 39. The second coil spring 37 is accommodated in the second spring chamber 39. The second coil spring 37 urges the second spool 34 toward the second pilot chamber 36. When the pressure in the priority flow path 18 shifts from a low state to a high state, that is, as the hydraulic pressure of the second pilot chamber 36 increases, the second spool 34 moves leftward in the axial direction of the spool 34 and shifts to the states shown in FIGS. 4 and 5. As a result, the switch valve 13 switches connections and connects the supply flow path 17 to the priority flow path 18 with the second flow path 135, which extends through the switch valve 13.

The second restrictions 35 are included in the second spool 34. When the switch valve 13 performs switching and moves the second spool 34 to the left as viewed in the states shown in FIGS. 4 and 5, the supply flow path 17 is connected to the priority flow path 18 through the second flow path 135, which includes the second restrictions 35. In this state, the second restrictions 35 each function as an orifice, or a fixed restriction, for restricting the flow rate of hydraulic oil from the supply flow path 17 to the priority flow path 18 through the switch valve 13. Each second restriction 35 extends radially inward from the outer surface of the second spool 34 and communicates with the cavity 55 of the second spool 34. The second pilot chamber 36 at the right end of the second spool 34, the second spring chamber 39 at the left end of the second spool 34, and the second restrictions 35 located between the second pilot chamber 36 and the second spring chamber 39 are connected to one another through an internal passage 56 in the second spool 34. Therefore, the hydraulic oil passing through the second restrictions 35 from the communication passage 38 is supplied to the priority flow path 18 through the internal passage 56 of the second spool 34 and the second pilot chamber 36. That is, fluid acting on a right end of the second spool 34 is drawn into the second pilot chamber 36, and the second pilot chamber 36 communicates with the priority flow path 18.

In the same manner as the first restrictions 26 of the first spool 23, the second restrictions 35 are located at two positions symmetric to the axis of the second spool 34. This offsets the fluid force acting on the second spool 34 in a direction perpendicular to the axial direction of the second spool 34.

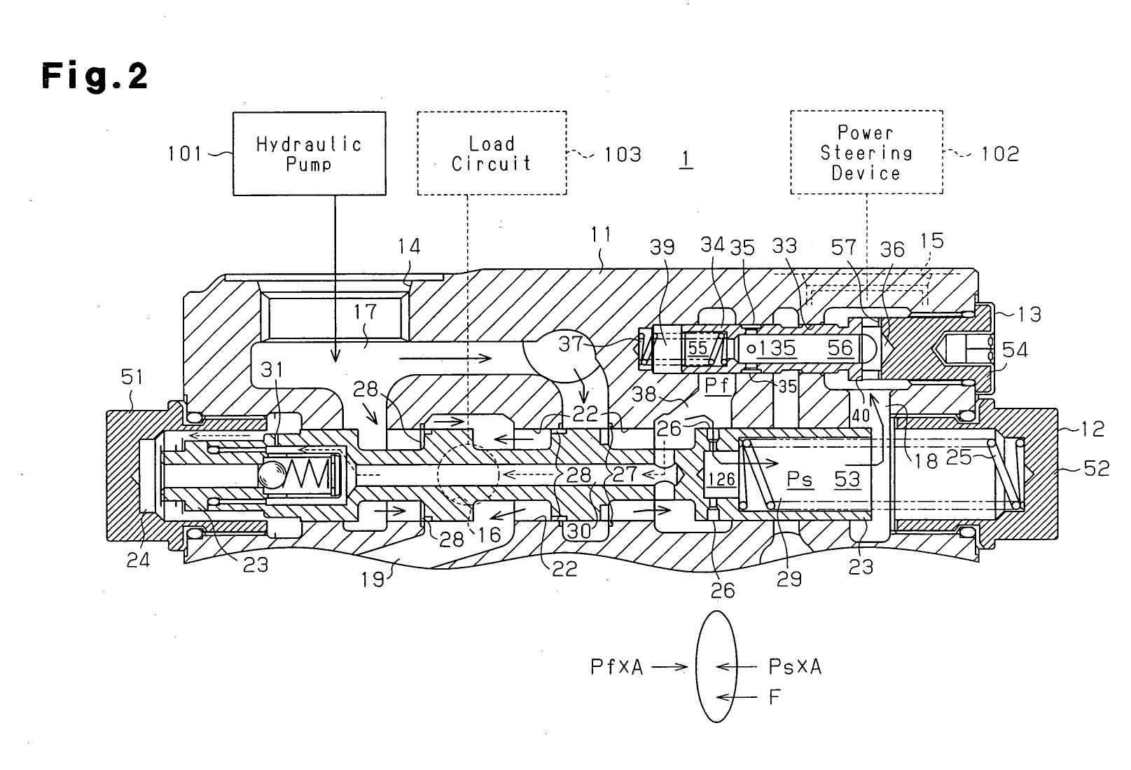

The operation of the flow rate switching type flow divider 1, that is, the operation for supplying hydraulic oil from the hydraulic pump 101 to the power steering device 102 at a predetermined flow rate of and to the load circuit 103 will now be described with reference to FIGS. 2 through 5.

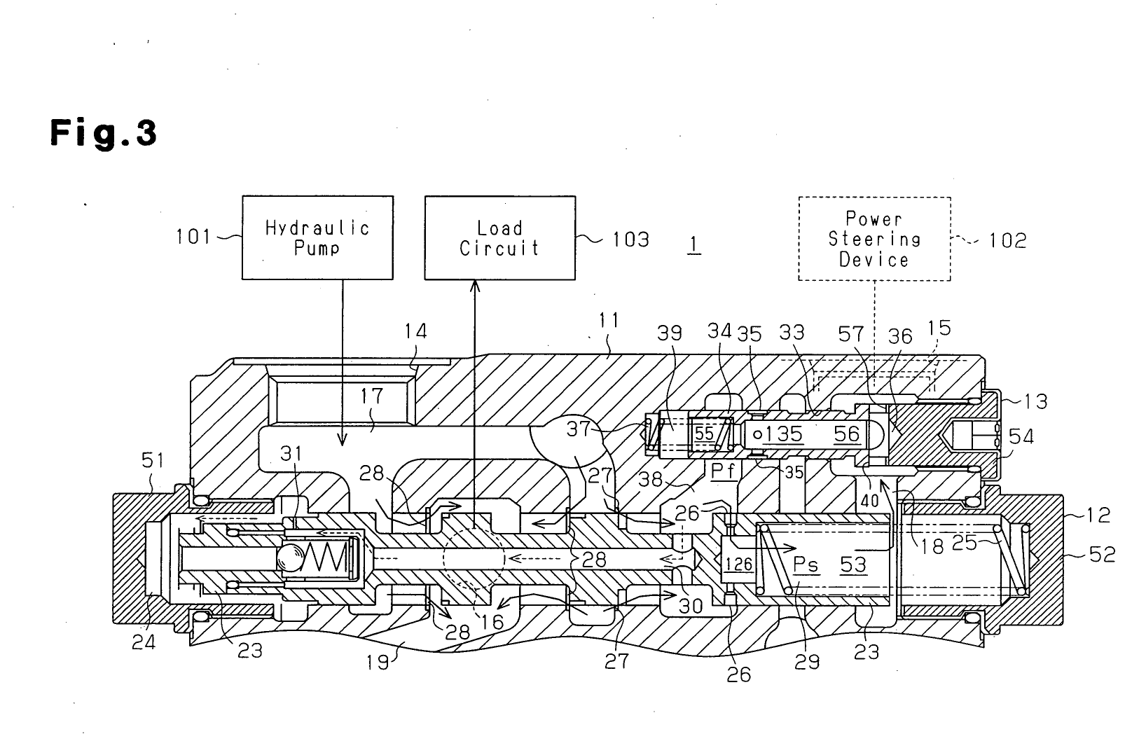

The state shown in FIG. 2 will first be described. In this state, there is no load generated by the power steering device 102, that is, the power steering device 102 is not actuated. Further, there is no load generated by the load circuit 103, that is, the hydraulic actuator of the load circuit 103 is not actuated. Then, the state shown in FIG. 3 will be described. In this state, load is only generated in the load circuit 103, that is, the pressure increase in the load circuit 103.

In the state shown in FIG. 2, the hydraulic oil supplied from the hydraulic pump 101 first flows into the supply flow path 17 from the pump port 14. Then, the hydraulic oil flows from the supply flow path 17 through the fourth restriction 28 and into the surplus flow path 19. The hydraulic oil further flows from the surplus flow port 16 to the load circuit 103. The hydraulic oil also flows from the supply flow path 17 through the third restriction 27 and into the communication passage 38. The hydraulic oil further flows through the first restrictions 26 formed in the first spool 23, the first spring chamber 29, the priority flow path 18, and the priority flow port 15 to the power steering device 102. That is, the hydraulic oil of the supply flow path 17 passes through the first flow path 126, which includes the first restrictions 26, and is supplied to the priority flow path 18.

The hydraulic pressure of the communication passage 38 upstream from the first restriction 26 is transmitted to the first pilot chamber 24 through the pilot flow path 30 and damper orifice 31 of the first spool 23 as indicated by the broken line indicating hydraulic pressure transmission in FIG. 2.

The hydraulic pressure of the communication passage 38 upstream from the first restrictions 26 is represented by Pf, and the hydraulic pressure of the priority flow path 18 and first spring chamber 29 downstream from the first restrictions 26 is represented by Ps. The cross-sectional area of the portion of the first spool 23 that moves along the wall surface defining the first spool hole 22 is represented by A, and the spring force of the first coil spring 25 in the first spring chamber 29 is represented by F. The first spool 23 is positioned in a balanced state in which the formula (1) is satisfied.

Pf×A=Ps×A+F (1)

In the balanced state in which formula (1) is satisfied, the difference between the hydraulic pressure Pf upstream from the first restrictions 26 and the hydraulic pressure Ps downstream from the first restrictions 26 is represented by ΔP. The pressure difference ΔP (Pf−Ps) corresponds to the pressure loss caused by the first restrictions 26. The relationship of formula (2) is derived from formula (1).

ΔP×A=F (2)

Accordingly, in the state shown in FIG. 2, the first spool 23 is held at a position in which the pressure difference ΔP of opposite sides of the first spool 23 maintains the balance between the force urging the first spool 23 from the first pilot chamber 24 to the first spring chamber 29 and the spring force F of the first coil spring 25 urging the first spool 23 in the opposite direction. In the balanced state, the first restrictions 26 communicate with the surplus flow path 19 through the communication passage 38, the third restriction 27, and the fourth restriction 28. Therefore, when a load is generated by the load circuit 103, the hydraulic pressure Pf upstream from the first restriction 26 is momentarily increased. This momentarily satisfies the relationship of formula (3).

Pf×A>Ps×A+F (3)

When the hydraulic pressure of the load circuit 103 increases and the relationship shown in formula (3), that is, ΔP×A>F, is momentarily satisfied, the balanced state of FIG. 2 can no longer be held.

The increased hydraulic pressure Pf, upstream from the first restrictions 26, acts on the first pilot chamber 24 through the pilot flow path 30 and damper orifice 31. This increases the hydraulic pressure of the first pilot chamber 24 and moves the first spool 23 from the first pilot chamber 24 toward the first spring chamber 29. Thus, the flow divider 1 shifts from the state shown in FIG. 2 to the state shown in FIG. 3.

When the first spool 23 shifts to the right to the state shown in FIG. 3, the open amount of the fourth restriction 28 increases and the open amount of the third restriction 27 decreases. Thus, the hydraulic oil supplied from the hydraulic pump 101 to the supply flow path 17 flows in increased quantity through the widened fourth restriction 28 to the surplus flow path 19 and load circuit 103. Furthermore, the narrowed third restriction 27 restricts the supply of hydraulic oil to the downstream communication passage 38, the priority flow path 18, and the power steering device 102. As a result, the hydraulic pressure Pf is reduced in the communication passage 38 upstream from the first restriction 26.

In this manner, the first spool 23 moves to reduce the hydraulic pressure Pf even when the hydraulic pressure Pf momentarily rises due to an increase in the pressure of in the load circuit 103 that satisfies the relationship of formula (3). Therefore, after the first spool 23 moves to the right, the balanced state represented by formula (1) is satisfied again.

As long as the spring force F of the first coil spring 25 remains constant throughout the movement of the first spool 23, the relationships of formula (1) and formula (2) are satisfied again as the position of the first spool 23 changes and varies the open amount of the third restriction 27 and the fourth restriction 28 even when the pressure of the load circuit 103 fluctuates, that is, not only when the pressure of the load circuit 103 increases but also when it decreases. Therefore, the pressure difference ΔP is kept substantially constant. Further, the flow rate of the hydraulic oil passing through the first restrictions 26 is kept substantially constant since the orifice diameter of the first restrictions 26, or the fixed restrictions, is constant.

The first spool 23 operates as described above. Thus, the flow rate of the hydraulic oil that flows from the supply flow path 17 through the first flow path, which includes the first restrictions 26, and to the priority flow path 18, the priority flow port 15, and the power steering device 102 is kept constant at the predetermined flow rate. Furthermore, the flow rate of the hydraulic oil that flows from the supply flow path 17 through the fourth restriction 28, the surplus flow path 19, the surplus flow port 16, and the load circuit 103 is varied in accordance with the pressure requirement of the load circuit 103.

If a pressure change occurs only in the load circuit 103 and does not occur in the power steering device 102, the pressure in the second pilot chamber 36 does not increase. Thus, the second spool 34 is held in a state in which the second coil spring 37 in the second spring chamber 39 urges the second spool 34 toward the second pilot chamber 36. In this state, the switch valve 13 does not perform a switching operation. Therefore, the open amount of the second restriction 35 of the second spool 34 remains closed by the wall surface of the second spool hole 33, as shown in FIGS. 2 and 3. That is, the second flow path 135, which includes the second restriction 35 and supplies hydraulic oil from the supply flow path 17 to the priority flow path 18, remains blocked. The position in which the switch valve 13 is closed by the wall surface of the second spool hole 33 is referred to as the block position of the switch valve 13.

In the flow rate switching type flow divider 1 shown in FIG. 2, there is no load generated in the load circuit 103 and in the power steering device 102. In FIG. 3, load is generated in the load circuit 103 but not in the power steering device 102. In this manner, when there is no load in the power steering device 102, the pressure of the power steering device 102 is lower than the predetermined pressure. The second spool 34 is urged toward the second pilot chamber 36 by the second coil spring 37 in the second spring chamber 39. A spool seat 40, which defines the second pilot chamber 36, is formed in the third cap 54. In the states shown in FIGS. 2 and 3, the second spool 34 is pressed against the spool seat 40 by the second coil spring 37. In this state, the switch valve 13 cannot perform the switch operation and is located at the block position in which the wall surface of the second spool hole 33 blocks the second restriction 35.

A through hole 57, which functions as part of the priority flow path 18 in the second pilot chamber 36 even when the second spool 34 is pressed against the spool seat 40 by the second coil spring 37, is formed in the spool seat 40.

The state shown in FIG. 4 in which the power steering device 102 is actuated and a load is thus generated will now be described. FIG. 4 is a partially enlarged cross-sectional view showing the switch valve 13 and the surrounding area. The switch valve 13 is switched from a state in which the second restriction 35 is blocked to a state enabling communication of the communication passage 38 with the priority flow path 18 through the second restriction 35. The position of the switch valve 13 in which the second restriction 35 is open is referred to as the open position of the switch valve 13.

In the drawings, the second spool 34 of the switch valve 13 is shown as having a constant outer diameter in the axial direction of the second spool 34. Actually, the outer diameter D2 of the second spool 34 at the portion arranged in the second pilot chamber 36 is slightly greater than the outer diameter D1 of the second spool 34 at the left end arranged in the second spring chamber 39. That is, the second spool 34 is formed so as to satisfy the relationship of D2>D1. In other words, the right end of the second spool 34 has a pressure receiving area that is greater than that of the left end of the second spool 34. In the body block 11, a drain groove 41, which opens to the second spool hole 33, is formed between the second pilot chamber 36 and the communication passage 38 relative to the axial direction of the second spool 34. An outer groove 42 is formed in the second spool 34 in correspondence with the drain groove 41. The second spool 34 is formed so that the portion between the outer groove 42 and the second pilot chamber 36 has the outer diameter dimension D2 and the portion between the outer groove 42 and the second spring chamber 39 has the outer diameter dimension D1.

Furthermore, the second pilot chamber 36 communicates with the second spring chamber 39 through the internal passage 56 of the second spool 34.

Assuming that the same hydraulic pressure is applied to the portion of the second spool 34 located in the second spring chamber 39 (outer diameter D1, cross-sectional area A1=π(D1)²/4) and the portion located in the second pilot chamber 36 (outer diameter D2, cross-sectional area A2=π(D2)²/4), a force is generated to urge the second spool 34 toward the second spring chamber 39 in accordance with the difference of the two cross-sectional areas (ΔA=A1−A2=π(D1)²/4−π(D2)²/4). This force counters the spring force of the second coil spring 37. When the urging force that is in accordance with the cross-section area difference ΔA exceeds the spring force of the second coil spring 37 that presses the second spool 34 against the spool seat 40, the second spool 34 moves away from the spool seat 40 and toward the second spring chamber 39.

Therefore, in the states shown in FIGS. 2 and 3, when a load is generated in the power steering device 102 and pressure of the power steering device 102 shifts from a low state to a high state, that is, when the pressure becomes higher than a predetermined pressure, the second spool 34 is moved by a predetermined stroke amount toward the second spring chamber 39 against the spring force of the second coil spring 37. In other words, the second spool 34 moves to a position in which the second restriction 35 opens to the communication passage 38, as shown in FIG. 4. Thus, the switch valve 13 switches to the communication position in which the supply flow path 17 communicates with the priority flow path 18 through the communication passage 38, second restriction 35, and internal passage 56.

FIG. 5 is a partial cross-sectional view showing the switch valve 13 in a balanced state and shifted to the communication position from the state shown in FIG. 2. When the pressure of the power steering device 102 increase from the low state of FIG. 2 to a state in which it is greater than the predetermined pressure, the switch valve 13 performs a switching operation such that the second spool 34 is positioned at the open position in which the second restriction 35 opens to the communication passage 38. This communicates the supply flow path 17 to the priority flow path 18 through the first flow path 126, which includes the first restriction 26, and to the priority flow path 18 through the second flow path 135, which includes the second restriction 35.

When the switch valve 13 is switched to the open position in which the second restriction 35 opens to the communication passage 38, the priority flow path 18 is supplied with hydraulic oil through the first restriction 26 and through the second restriction 35. Therefore, when the switch valve 13 is shifted to the open position, the pressure difference ΔP=Pf−Ps of the hydraulic pressure Pf upstream from the first restriction 26 and the second restriction 35 and the hydraulic pressure Ps of the priority flow path 18, or the hydraulic pressure Ps downstream from the first restriction 26 and the second restriction 35, becomes less than before the switch valve 13 was shifted to the open position. That is, when the switch valve 13 is shifted to the open position, the pressure difference is of the pressure Pf upstream from the first restrictions 26 is less than the pressure difference of the pressure Ps downstream from the first restrictions 26. The relationship shown in formula (4), which approximates the cross-sectional areas A1 and A2 with cross-sectional area A for the sake of simplification, is momentarily satisfied.

Pf×A<Ps×A+F (4)

An increase in the pressure of the power steering device 102 increases the pressure Ps downstream from the first restriction 26 and shifts the switch valve 13 to the communication position. When the relationship of formula (4) is momentarily satisfied, that is, when the balanced state of formula (1) becomes unsatisfied, the first spool 23 moves from the first spring chamber 29 toward the first pilot chamber 24 until the balanced state represented by the relationship of formula (1) is satisfied again. When the first spool 23 moves to the first pilot chamber 24, the open amount of the fourth restriction 28 is decreased and the open amount of the third restriction 27 is increased. This increases the hydraulic pressure Pf downstream from the first restriction 26. As a result, the balanced state of formula (1) is satisfied again.

Therefore, when the power steering device 102 is under high pressure as shown in the state of FIG. 5, and the second spool 34 of the switch valve 13 is shifted to the communication position of the second restriction 35, the first restriction 26 allows for the passage of hydraulic oil, and the second restriction 35 also allows the passage of hydraulic oil. Then, the balanced position of the first spool 23 is determined so as to satisfy the balanced state satisfying the relationship of formula (1) which specifies that the pressure difference ΔP=Pf−Ps is constant between the hydraulic pressure Ps of the priority flow path 18 and the hydraulic pressure Pf that is upstream from the second restriction 35 and also upstream from the first restriction 26.

In the flow rate switching type flow divider 1 of the present embodiment, the flow divider valve 12 supplies hydraulic oil at a predetermined flow rate through the first restriction 26 to the power steering device 102 (priority flow path). Further, the remaining flow rate that is not supplied to the power steering device 102 is supplied to the load circuit 103 (surplus flow path). The portion of the supply flow path 17 upstream from the first restriction 26 is connected to the priority flow path 18 through the second flow path 135 by operating the switch valve 13. Accordingly, the fluid from the hydraulic pump 101 also flows through the second flow path 135, which includes the second restriction 35 and is supplied to the power steering device 102. Thus, the switching of the predetermined flow rate of the fluid supplied to the power steering device 102 is enabled.

In addition, the switch valve 13 in the flow rate switching type flow divider 1 is arranged along a line that differs from the line along which the flow divider valve 12 is arranged in the body block 11. Thus, the switch valve 13 and the flow divider valve 12 are not arranged along the same straight line. That is, the switch valve 13 and the flow divider valve 12 are arranged so that they do not elongate the flow rate switching type flow divider 1. This prevents the flow rate switching type flow divider from becoming long in the axial direction of the spool. Therefore, the flow divider may be miniaturized, and the need of a long installation space for the flow rate switching type flow divider 1 is eliminated. This enables the flow rate switching type flow divider 1 to be easily installed without restrictions in the longitudinal direction.

In this case, various conditions, such as the lengths of the first spool 23 and the second spool 34, the stroke lengths of the first spool 23 and the second spool 34, and the specifications of the internal first coil spring 25, urging spring 32c, and second coil spring 37, are not affected by design restrictions. Further, instability of the controlled flow rate and increase in pressure loss within the hydraulic circuit that would be caused by such design restrictions are suppressed.

The switch valve 13 includes the second restriction 35 that communicates with the priority flow path 18. The second restriction 35 communicates with the supply flow path 17 upstream from the first restriction 26 through the flow divider valve 12. That is, the second flow path 135, which includes the second restriction 35, branches from the first flow path 126 at a portion midway in the longitudinal direction of the first spool 23. This shortens the second flow path 135. Thus, a complex hydraulic circuit is not required to operate the switch valve 13. This simplifies the structure of the hydraulic circuit structure. Accordingly, the flow rate switching type flow divider 1 may be miniaturized since the longitudinal dimension is shortened, and the structure of the operating fluid circuit structure is simplified.

In the flow rate switching type flow divider 1, the switch valve 13 is shifted when the pressure of the power steering device 102 is high. As a result, fluid is supplied from the hydraulic pump 101 to the power steering device 102 at a predetermined flow rate through the second flow path 135, which includes the second restriction 35. The switch valve 13 also switches the flow rate of the fluid supplied to the power steering device 102 in accordance with the load of the power steering device 102.

In the flow rate switching type flow divider 1, the flow divider valve 12 and switch valve 13 are arranged parallel to each other. Thus, these valves may be arranged in a concentrated manner. This enables the flow rate switching type flow divider to be miniaturized.

In the flow rate switching type flow divider 1, the first spool hole 22 is formed in the body block 11. The first spool 23, which includes the first restriction 26, is arranged in the first spool hole 22. This simplifies the structure of the flow divider valve 12.

In the flow rate switching type flow divider 1, pressure loss is reduced by having the hydraulic oil from the first restriction 26 pass through the pilot flow path 30, which functions as the internal flow path of the first spool 23. Furthermore, the interior space of the first spool 23 is used effectively. The first restriction 26 is formed in the wall of the hollow cylindrical first spool 23. Therefore, the first restriction 26 may easily be formed so that it is adjusted with high accuracy. This improves the design accuracy of the first restriction 26.

In the flow rate switching type flow divider 1, the second spool hole 33 is formed so as to enable the first spool hole 22 to communicate with the priority flow path 18. Moreover, the second spool 34, which includes the second restriction 35, is arranged in the second spool hole 33. In this way, the switch valve 13 has a simple structure.

In the flow rate switching type flow divider 1, pressure loss is reduced by having the hydraulic oil from the second restriction 35 flow through the internal passage 56 of the second spool 34. Moreover, the interior space of the second spool 34 is used effectively. Further, the second restriction 35 is formed in the wall of the hollow cylindrical second spool 34. Therefore, the second restriction 35 is easily formed so that it can be adjusted with higher accuracy. This improves the design accuracy of the second restriction 35.

In the flow rate switching type flow divider 1, the third restriction 27 and fourth restriction 28 are defined by the wall surface of the first spool hole 22 and the first spool 23 upstream from the first restriction 26. Therefore, the flow rate of the hydraulic oil supplied to the surplus flow path 19 may be varied so as to supply the hydraulic oil at a predetermined flow rate from the supply flow path 17 to the priority flow path 18 by moving the first spool 23 in the first spool hole 22. Thus, the flow divider valve 12 may be easily formed.

In the flow rate switching type flow divider 1, the third restriction 27 is defined by the surface of the first spool hole 22 and a notch provided in the first spool 23. Therefore, the open amount of the third restriction 27 may be proportionally increased and decreased in accordance with the movement of the first spool 23. Thus, the third restriction 27 may easily be formed so as to enable adjustment with high accuracy. This improves the design accuracy of the third restriction 27. Moreover, the controlled flow rate is stabilized downstream from the third restriction 27.

In the flow rate switching type flow divider 1, the pilot flow path 30 directs the pressure of the hydraulic oil branched to the priority flow path 18 upstream from the first restriction 26 to the first pilot chamber 24. The pilot flow path 30 effectively uses the interior space of the first spool 23.

In the flow rate switching type flow divider 1, the switch valve 13 includes the second pilot chamber 36. One end of the second spool 34 is positioned in the second pilot chamber 36. Furthermore, the second pilot chamber 36 communicates with the priority flow path 18. Therefore, the structure for switching the switch valve 13 in accordance with the hydraulic pressure of the priority flow path 18 is easily realized with a simple structure.

In the flow rate switching type flow divider 1, the outer diameter dimension D2 of the portion of the second spool 34 arranged in the second pilot chamber 36 is formed so as to be larger than the outer diameter D1 of the portion of the second spool 34 accommodated in the second spring chamber 39. The second spring chamber 39 and second pilot chamber 36 of the switch valve 13 communicate with each other through the internal passage 56 of the second spool 34. In this manner, the switch valve 13 moves the second spool 34 toward the second spring chamber 39 in accordance with the hydraulic pressure in the priority flow path 18. Thus, a simple structure in which the outer diameter of the second spool 34 is properly set simplifies the formation of the switch valve 13 that performs switching in accordance with the hydraulic pressure in the priority flow path 18.

It should be apparent to those skilled in the art that the present invention may be embodied in many other specific forms without departing from the spirit or scope of the invention. Particularly, it should be understood that the present invention may be embodied in the following forms.

(1) The present embodiment has been described by way of example when the flow divider valve 12 and switch valve 13 are arranged along parallel lines. However, they need not necessarily be arranged on parallel lines insofar as the flow divider valve 12 and switch valve 13 are both arranged along different lines. For example, the flow divider valve 12 and switch valve 13 may be arranged at skew positions along lines that do not intersect with each other no matter how long the lines are extended.

(2) The present embodiment has been described for a case in which the switch valve 13 is shifted to the communication position by the pressure of the priority flow path 18. However, the present invention is not necessarily limited to this arrangement. For example, the switch valve 13 also may be configured as an electromagnetic valve. In this case, for example, the switch valve 13 may be an electromagnetic valve that performs a switching operation when excited by the actuation of the power steering device 102.

(3) Although the first restriction 26 and second restriction 35 are orifices in the preferred embodiment, the present invention is not limited in such a manner. For example, the present invention may also be applied when the first restriction 26 and second restriction 35 are formed as chokes. Furthermore, in the preferred embodiment, the first restriction 26 is formed at two locations and the second restriction 35 is formed at two locations. However, these elements may each be formed at only one location or at three or more locations.

(4) The above embodiment has been described for a case in which the hydraulic oil from the first restriction 26 flows through the internal passage of the cylindrical first spool 23 and the hydraulic oil from the second restriction 35 flows through the internal passage of the cylindrical second spool 34. However, the present invention is not limited in this manner. For example, the first restriction may be formed between the first spool 23 and the first spool hole 22. Then, the flow path may be formed such that, after flowing through the first restriction, the hydraulic oil is directed to the priority flow path 18 in the axial direction of the first spool 23 along the outer surface of the first spool 23.

(5) In the above embodiment, the third restriction 27 is defined by a notch formed on the surface of the first spool hole 22 and a notch formed on the first spool 23. However, the present invention is not necessarily limited in this manner. Further, the third restriction 27 may be omitted.

(6) In the preferred embodiment, although the communication passage 38, which is the flow path upstream from the first restriction 26, communicates with the first pilot chamber 24 through the pilot flow path 30 in the first spool 23, the present invention is not necessarily limited in such a manner. For example, the communication passage 38 upstream from the first restriction 26 may also communicate with the first pilot chamber 24 through a flow path formed in the body block 11.

The present examples and embodiments are to be considered as illustrative and not restrictive, and the invention is not to be limited to the details given herein, but may be modified within the scope and equivalence of the appended claims.

1. A flow rate switching type flow divider for distributing fluid supplied from a pump to a priority flow circuit and a surplus flow circuit, the flow divider comprising:
a housing including a pump port connectable to the pump, a priority flow port connectable to the priority flow circuit, a surplus flow port connectable to the surplus flow circuit, a supply flow path extending from the pump port, a priority flow path extending from the priority flow port, and a surplus flow path extending from the surplus flow port;
a flow divider valve arranged in the housing so as to communicate with the supply flow path, the priority flow path, and the surplus flow path, the flow divider valve distributing fluid from the supply flow path to the priority flow path and the surplus flow path, wherein the flow divider valve is arranged along a first line;
a first restriction arranged in the flow divider valve between the supply flow path and the priority flow path to restrict flow rate of the fluid from the supply flow path to the priority flow path; and
a switch valve arranged in the housing along a second line that differs from the first line so as to communicate with the priority flow path,
wherein
the switch valve communicates with the supply flow path through the flow divider valve at a location upstream from the first restriction,
the flow divider further comprising:
a connection flow path bypassing the first restriction and extending from the supply flow path to the priority flow path, the switch valve switching connection between the supply flow path and the priority flow path through the connection flow path; and
a second restriction arranged in the switch valve for restricting flow rate of fluid flowing from the supply flow path via the switch valve and into the priority flow path.

2. The flow divider according to claim 1, wherein the flow divider includes a first spool movable along the first line, and the switch valve includes a second spool movable along the second line.

3. The flow divider according to claim 1, wherein the switch valve is switched to connect the supply flow path to the priority flow path through the connection flow path when the priority flow path shifts from a low pressure state to a high pressure state.

4. The flow divider according to claim 1, wherein the first line and the second line are parallel to each other.

5. The flow divider according to claim 1, wherein:
the housing includes a first spool hole communicated with the supply flow path, the priority flow path, and the surplus flow path; and
the flow divider includes a first spool movably arranged in the first spool hole, movement of the first spool along the first line varying the flow rate of the fluid flowing to the surplus flow path, wherein the first spool includes the first restriction.

6. The flow divider according to claim 5, wherein the first spool includes a hollow cylindrical portion defining an internal passage, and the fluid that has passed through the first restriction flows into the internal passage and to the priority flow path.

7. The flow divider according to claim 1, wherein:
the housing includes a second spool hole communicated with the priority flow path, and the second spool hole is communicated through the connection flow path with the first spool hole; and
the switch valve includes a second spool movably arranged in the second spool hole, the supply flow path being connected to the priority flow path through the connection flow path by moving the second spool along the second line, and the second spool including the second restriction.

8. The flow divider according to claim 7, wherein the second spool includes a hollow cylindrical portion defining an internal passage, in which fluid that has passed through the second restriction flows into the internal passage and to the priority flow path.

9. The flow divider according to claim 5, wherein the flow divider valve includes:
a third restriction for communicating the supply flow path with the priority flow path; and
a fourth restriction for communicating the supply flow path with the surplus flow path, the third restriction and the fourth restriction each being located upstream from the first restriction and defined between the first spool and a wall surface of the first spool hole.

10. The flow divider according to claim 9, wherein the third restriction is defined by the wall surface of the first spool and a notch formed in the first spool.

11. The flow divider according to claim 9, wherein:
the flow divider valve includes a first pilot chamber into which fluid is drawn to act on one end of the spool; and
the first restriction and the third restriction are connected by a flow path communicated with the first pilot chamber through a flow path formed in the first spool.

12. The flow divider according to claim 7, wherein:
the second spool includes a first end and an opposite second end; and
the switch valve includes a second pilot chamber into which fluid is drawn to act on the first end, with the second pilot chamber communicating with the priority passage.

13. The flow divider according to claim 12, wherein:
the switch valve includes a spring, for urging the second end of the second spool toward the second pilot chamber, and a spring chamber, for receiving the spring;
the second pilot chamber and the spring chamber are communicated with each other through an internal passage of the second spool; and
the first end has a pressure receiving area that is greater than that of the second end.
